(19) United States
(12) Patent Application Publication
(10) Pub. No.: US 2009/0013819 A1
(43) Pub. Date: Jan. 15, 2009

(54) AERO SUPPORTING DEVICE FOR BICYCLES AND THE LIKE

(76) Inventor: Morgan Nicol, Barbengo (CH)

Correspondence Address: GREER, BURNS & CRAIN, LTD., Suite 2500, 300 South Wacker Drive, Chicago, IL, 60606, US

(21) Appl. No.: 12/167,462

(22) Filed: Jul. 3, 2008

(30) Foreign Application Priority Data
Jul. 2, 2007 (DE) 10 2007 030 762.6

(51) Int. Cl. B62K 21/12

(52) U.S. Cl. 74/551.8; 74/551.1

(57) ABSTRACT

An aero supporting device for a bicycle, including two elongated aero supports that extend in a front direction of a bicycle when used in accordance with the intended purpose and which can be gripped by a user, as well as two arm rests on which a user can rest his forearms or elbows, for e.g. attaining a reduced drag, wherein a covering device is provided which jointly surrounds at least the two aero supports.

### BACKGROUND

The invention relates to an aero supporting device for bicycles and the like. Aero supporting devices have become known in the prior art which allow the user to assume an aerodynamically efficient and comfortable position on a bicycle.

In competitive racing, aerodynamic drag is a significant factor. This applies in particular to triathlon runs where regulations prohibit utilizing wake flow such that aerodynamic drag is of central importance. To reduce aerodynamic drag, e.g. aerodynamically efficient wheels are used. Moreover, the riding position of the cyclist is optimized so as to minimize the frontal surface area. To this end, so-called aero supports are employed as a component of the handlebar or mounted to the handlebar. Other than the aero supports, arm or elbow rests are often provided for the user to place his underarms on and as a support. Concurrently the user can grip front aero support areas with his hands. In this way the user assumes a flat position on the bicycle that reduces aerodynamic drag.

In many cases, the aero supports are designed as two separate supports, often terminating horn-like at the front end. During pedaling the rider can simultaneously pull at both aero supports to transfer particularly high forces to the pedals. To achieve an optimum of force transfer and comfort, the aero supports may be configured in an incline, rising toward the front. This kind of aero supports ending in a point and inclined forwardly and upwardly may carry an increased risk of injury to the user, to spectators in competitions, or pedestrians during training, in case of accidents.

The risk of injury is reduced with the two aero supports connected with each other in the front region to form a loop. However, this requires more material and manufacturing steps. Since the design is one major aspect for a bicycle component, a connecting loop should not only meet technical requirements but also be appealing, which further increases the extent of construction and material requirements.

Another drawback of known aero supports is that aerodynamic drag is high since a great deal of local turbulence builds up at the supports.

It is therefore the object of the present invention to provide an aero supporting device which exhibits a reduced risk of injury.

### SUMMARY

The aero supporting device according to the invention is provided for a bicycle, comprising at least two supporting components formed as elongated aero supports which, when a bicycle is used as intended, substantially extend forwardly and which may be gripped by a user. Furthermore the aero supporting device comprises at least two supporting components formed as arm rests for a user to support his forearms or elbows on, e.g. to achieve reduced aerodynamic drag. According to the invention, at least one covering device is provided which jointly surrounds at least two of the supporting components.

The invention has many advantages. It is a significant advantage that the user, spectators, or pedestrians are better protected from injury in the case of an accident since the tips of the aero supports extending forwardly are received in the covering device. Furthermore the covering device achieves a more aerodynamically efficient shape such that aerodynamic drag is reduced. Due to the covering device jointly covering the two or more aero supports the amount of turbulence generated is reduced which decreases aerodynamic drag.

The term “aero” in the sense of the present application is understood to mean an abbreviation of “aerodynamic”, such that e.g. the aero supports may be referred to as aerodynamic supports. The aero supports may but do not need to be designed to be aerodynamic. Rather, the “aero” components allow an aerodynamic position on the bicycle.

Advantageously two or more covering devices may be provided which e.g. surround portions of the aero supporting device.

In preferred embodiments a covering device jointly surrounds the two elongated aero supports. It is also preferred that the same or a different covering device jointly surrounds the two arm rests.

In other embodiments, one covering device jointly surrounds one elongated aero support and one arm rest such that the right/left sides are in particular divided.

In all of the cases the elongated aero supports formed e.g. as struts are in particular about as long as a forearm. Preferably the length is between approximately 20 cm and approximately 35 cm, or between approximately 8 and 14 inches.

The elongated aero supports are preferably positioned adjacent to each other and may protrude fork-like from one common support, such that the elongated aero supports pass into one common support or holder while at the front the supports terminate in separate ends.

It is also preferred to provide two or more short aero supports or grip ends which are in particular positioned at the outwardly sides of the aero supporting device. The length of the short aero supports is in particular approximately half that of the elongated aero supports. Preferably the free length of the short aero supports is between 10 cm and 20 cm, or between approximately 4 and 8 inches.

The covering device may consist of or contain a woven fabric.

In all of the embodiments the covering device consists of an elastic and/or flexible material or of multiple flexible materials, at least in part. Preferably the covering device consists of latex or silicone, at least in part. If the covering device contains a fabric, it consists in particular of elastic fibers such as spandex or elastane, or similar or comparable fibers.

The two or more arm rests of the aero supporting device may be formed as separate arm resting units. It is, however, also possible to provide two or more arm rests at one arm resting unit.

All of the embodiments preferably provide for the arm rests to also be surrounded by covering devices. Preferably the bicycle computer is also received in and protected by the covering device.

The covering device comprises in particular holes for passing through or mounting the arm rests. For example multiple small holes may be provided through which connecting elements can be passed. Said connecting elements are considerably smaller in diameter than the arm rests.

Preferred specific embodiments provide for the aero supporting device to comprise a connecting unit for connecting the two elongated aero supports at the front end. The connecting unit may for example be designed as a rod and comprise cylinder-shaped holes for receiving the aero support ends. The connecting unit may form part of the covering device. Said connecting unit or said bridging element is preferably covered by the outer sheath of the covering body of the covering device. Therefore the optical design of the connecting unit is not very important in the present invention since during operation the connecting unit is covered by the covering device and thus it does not need to be designed in respect of optical and esthetical aspects but may in particular be designed in respect of technical and economical aspects. This reduces work in manufacturing.

All of the embodiments preferably provide for the covering device to comprise shock-absorbing areas which in particular cover protruding corners and/or are positioned at the ends of the aero supports. The shock-absorbing areas comprise in particular additional padding formed by a plurality of air- or gel-filled, chamber-like sections. Such a shock-absorbing area is in particular provided at the connecting unit which connects the aero supports with one another.

Preferably the covering device is aerodynamic in design. The covering device comprises in particular smooth top and bottom surfaces so as to provide plane surfaces between the elongated aero supports.

Preferably the aero supporting device is formed as a handlebar or it comprises a handlebar.

The covering device according to the invention is provided for an aero supporting device of a bicycle, comprising at least one flexible covering body which is suitable for entirely surrounding forwardly, upwardly and downwardly, at least two aero supports of a handlebar.

Such a covering device is very advantageous since it offers an increased protection from injury by way of covering the aero supports.

Preferably the covering body comprises a connecting unit for connecting the front ends of two aero supports.

The covering body comprises in particular an elastic and flexible top and bottom surface formed by elastic and flexible top and bottom layers. This allows a user to wrap his hands around the aero supports although they are surrounded by the covering body because the fingers can push the elastic top layer and bottom layer away so as to allow a firm grip although the cover is actually smooth.

All of the embodiments preferably provide for the covering body to be matched for mounting to aero supports of different sizes.

Preferably the covering body comprises sizeable padding to be capable of absorbing shocks.

In particular the covering body comprises a woven fabric consisting preferably of elastic fibers. In addition to elastic fibers, a portion of reinforcing fibers may be incorporated to achieve, other than high elasticity, also high strength. For example aramidic fibers, carbon fibers, boron fibers, glass fibers, or ceramic fibers may be woven in. Preferably, fibers of high tearing resistance and a low specific weight are used.

In all of the specific embodiments the fabric preferably has a smooth covering layer.

### BRIEF DESCRIPTION OF THE DRAWINGS

Further advantages and applications can be taken from the exemplary embodiments described below with reference to the Figures.

FIG. 1 is a schematic top view of a first embodiment of an aero supporting device according to the present invention;

FIG. 2 is a side view of the elongated aero supports of the aero supporting device according to FIG. 1;

FIG. 3 is a schematic top view of a second embodiment of an aero supporting device according to the present invention; and

FIG. 4 is a schematic bottom view of the aero supporting device according to FIG. 3.

### DETAILED DESCRIPTION OF THE PREFERRED EMBODIMENT

Variants of an embodiment of the present invention will now be described with reference to the Figures.

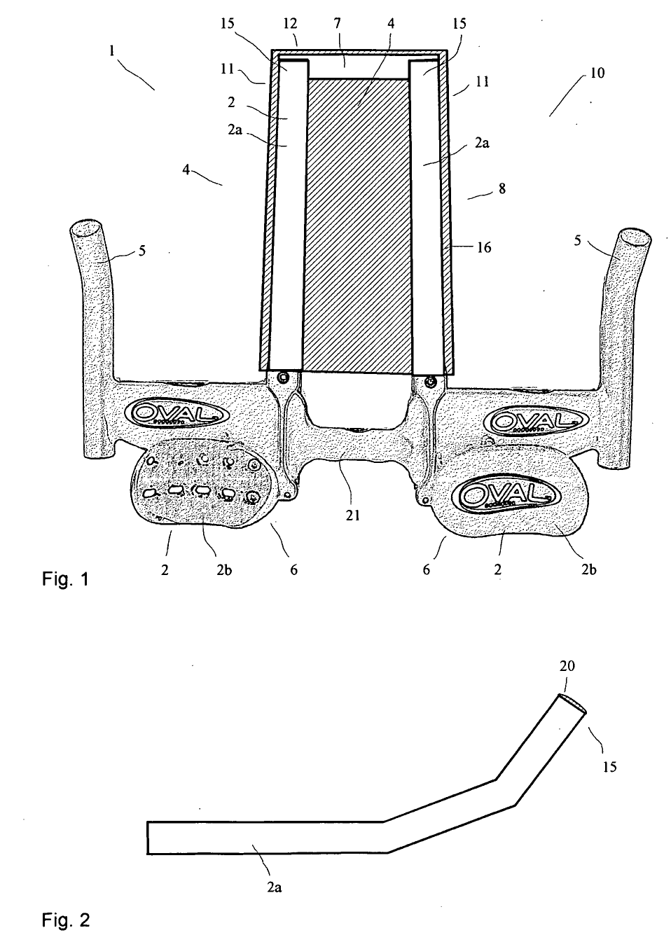

FIG. 1 shows a schematic top view of an aero supporting device 1 according to the present invention, which is formed as a handlebar 10 in this case. In other embodiments the aero supporting device 1 may be formed as a separate part to be connected with the handlebar or the stem of the bicycle.

The handlebar 10 comprises a transverse beam 21, at whose outer ends short aero supports 5 are provided which are formed as bar ends. Connection with the stem occurs in a central region at or beneath the transverse beam 21.

The aero supporting device 1 in this embodiment comprises a total of four supporting components 2, two aero supports 2a, and two arm rests 2b.

In the center between the short aero supports 5 the two elongated aero supports 2a are provided at a distance from each other and extending forwardly. The length of the aero supports 2a depends on the specific requirements, being in particular between approximately 25 and 30 cm, while the short aero supports 5 are approximately 10 to 15 cm in length and may be provided with brake and/or shift grips at their ends.

The front ends 15 of the elongated aero supports 2a may be provided with shift grips or shift levers (not shown), wherein corresponding small holes will be provided in the covering device 8 for guiding the shift levers through.

The sideward distance of the elongated aero supports 2a in the embodiment is between approximately 7 cm and 15 cm, while the overall width is approximately 35 to 45 cm.

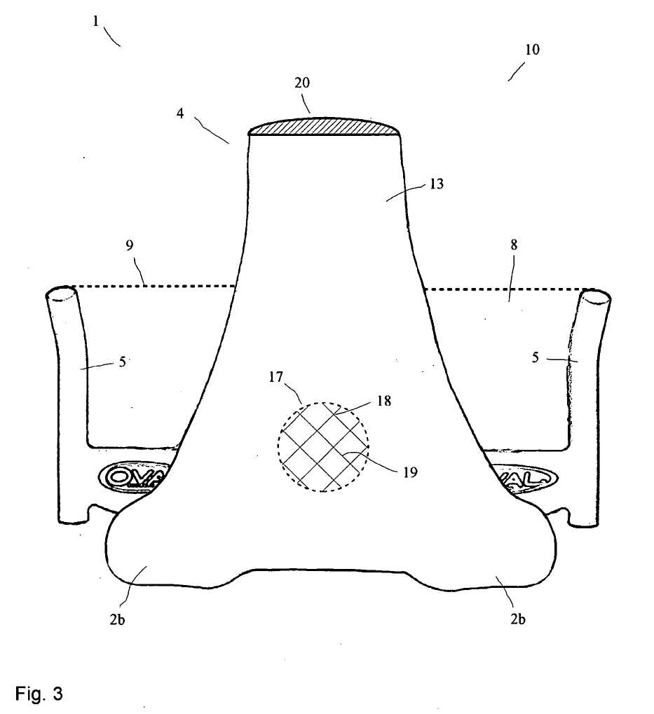

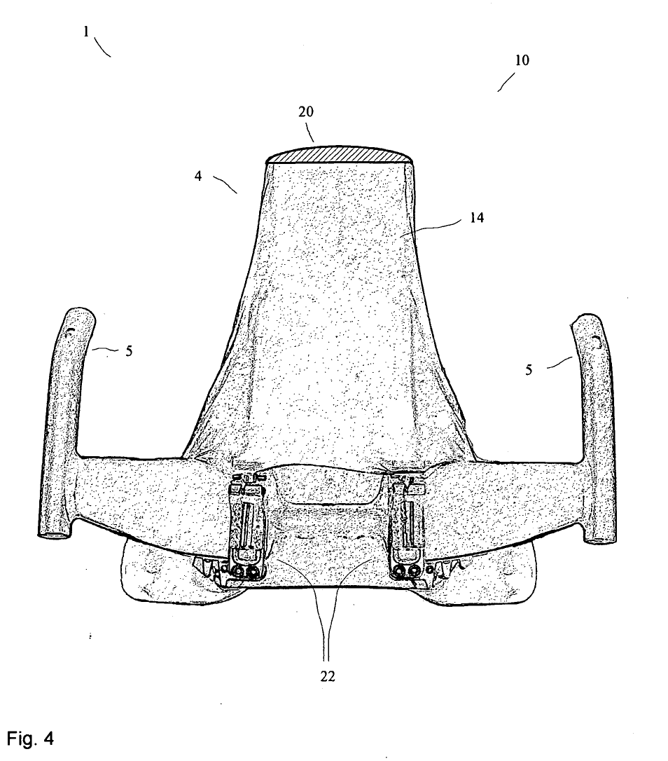

The elongated aero supports 2a are surrounded according to the invention by a covering body 8 comprising a top surface 13 and a bottom surface 14 (see FIGS. 3, 4). Another part of the covering device 4 is the connecting unit 7 which connects the front ends 15 of the elongated aero supports 2a with one another. In this way a possible danger to the rider and other third parties in the case of accidents etc. is reduced, in particular if aero supports 2a are used that are curved upwardly as illustrated in FIG. 2.

The shown covering device 4 comprises a flexible padding layer 16 which surrounds the aero supports forwardly, and upwardly and downwardly. There are thus obtained shock-absorbing areas 11 and 12 at the side and in particular at the front end 15, which in the case of accidents absorb a considerably portion of the collision impulse and thus considerably contribute to safety. The shock-absorbing areas 11 and 12 may comprise special reinforcements in strategic places, in particular in the region of the front ends 15 of the aero supports 2a.

The covering body 8 may be attached to the aero supporting device 1 by means of loops to prevent inadvertent unfastening.

The fact that the elongated aero supports 2a are substantially entirely surrounded by the covering body 8 downwardly, upwardly, and forwardly, also achieves enhanced aerodynamic drag, as the number of individual obstructions to air flow is reduced which cause a respective reduced number of disturbances.

According to the invention, both the safety and the aerodynamic situation of the rider are thus enhanced.

Advantageously, flexible and elastic materials are used in the embodiment for the surfaces of the covering body 8. Thus, the rider can wrap his fingers around the aero supports 2a despite the covering body 8 because the surfaces of the covering body 8 are configured to yield.

The elongated aero supports 2a illustrated in FIG. 2 are angled upwardly in two segments. A shock-absorbing area 20 is provided at the front end 15 which is illustrated in a schematic section and covers the front end 15.

In the schematic embodiment illustrated in FIG. 2, the covering device 4 surrounds not only the elongated aero supports 2a but also the arm rests 2b configured as separate arm supporting units 6.

The area 17 illustrated in a schematic section shows a schematic enlargement of the top surface 13. The covering body 8 comprises a fabric 18 comprising fibers arranged at right angles. Generally the fabric may consist of different natural materials or of synthetic fibers. For example, thermoplastic fibers may be used.

In preferred embodiments, reinforcement fibers are used in part or in whole as they are employed in fiber-reinforced plastics.

The fabric 18 may be coated with a smooth covering layer. For example a rubber-like layer may be provided at the surface.

It is also possible that the entire covering device 4 consists e.g. of spandex or the like, or latex or silicone or similar or comparable materials.

The aero supports 2a configured as in FIG. 1 are covered at the front end by a shock-absorbing section 20 or portion. The shock-absorbing portion 20 comprises air-filled chambers which in the case of a violent impact are compressed and possibly destroyed. In this process, the shock-absorbing region 20 absorbs a considerable portion of the impact energy such that the rider and third parties are better protected from injury. Furthermore, aerodynamics are enhanced since the front edge has an aerodynamically efficient design.

The dashed line 9 indicates another covering body 8 which may optionally be provided at the short aero supports 5 to cover these supports as well, thus optimizing aerodynamic drag.

FIG. 4 illustrates a bottom view of the aero supporting device 1 according to FIG. 3, which can be attached to a handlebar through fastening elements 22. The bottom surface 14 comprises multiple plane surfaces covering sharp-edged parts or points. In the case of accidents, the risk of injury is considerably reduced also in case of contact with bottom areas of the aero supporting device 1.

All of the embodiments may provide a transparent window or a hole through which the bicycle computer can be read and operated.

The flexible and elastic configuration allows to employ the covering device 4 with aero supporting devices 1 of various dimensions, so as to reduce the necessity of manufacturing different sizes.

The arm rests may also be provided with cutouts e.g. for providing the arm rests, which are equipped with Velcro strips, with corresponding coverings.

It is another advantage of the invention that in the case of accident, broken parts, splinters and the like remain within the covering device 4, such that e.g. the risk of being cut is reduced for the rider and third parties.

1. An aero supporting device for a bicycle, comprising: at least two support components structured as elongated aero supports that extend in a front direction of a bicycle when used in accordance with the intended purpose and which can be gripped by a user, as well as at least two support components structured as arm rests on which a user can rest his forearms or elbows, for e.g. attaining a reduced drag, and at least one covering device is provided, which jointly surrounds at least two of the support components.

2. The aero supporting device according to claim 1, wherein the covering device jointly surrounds the two elongated aero supports.

3. The aero supporting device according to claim 1, wherein the covering device jointly surrounds the two elongated aero supports.

4. The aero supporting device according to claim 1, wherein two covering devices are provided.

5. The aero supporting device according to claim 1, wherein each covering device jointly surrounds an elongated aero support and an arm rest.

6. The aero supporting device according to claim 1, wherein the elongated aero supports are between 20 cm and 35 cm in length.

7. The aero supporting device according to claim 1, wherein two short aero supports are provided which are arranged at the outer sides, wherein the short aero supports are between 10 cm and 20 cm in free length.

8. The aero supporting device according to claim 1, wherein the covering device consists of an elastic and flexible material at least in part.

9. The aero supporting device according to claim 1, wherein the covering device consists of a woven fabric at least in part.

10. The aero supporting device according claim 1, wherein the covering device consists of a material, at least in part, that is taken from a group consisting of elastic materials, spandex, latex, and silicone.

11. The aero supporting device according to claim 1, wherein the two arm rests are designed as separate arm rest units.

12. The aero supporting device according to claim 1, wherein the covering device comprises holes for passing through the arm rests.

13. The aero supporting device according to claim 1, comprising a connecting unit for connecting the two elongated aero supports at the front end.

14. The aero supporting device according to claim 13, wherein the connecting unit is part of the covering device.

15. The aero supporting device according to claim 1, wherein the covering device comprises shock absorbing areas.

16. The aero supporting device according to claim 1, wherein the covering device is aerodynamic in design.

17. The aero supporting device according to claim 1, wherein the covering device comprises a smooth upper and lower surface, such that between the elongated aero supports plane surfaces are provided.

18. The aero supporting device according to claim 1, which is designed as a handlebar.

19. A covering device for an aero supporting device of a bicycle, comprising: a covering body, which is suitable for entirely surrounding forwardly, upwardly and downwardly at least two aero supports of a handlebar.

20. The covering device according to claim 19, wherein the covering body comprises a connecting unit for connecting the front ends of two aero supports.

21. The covering device according to claim 19, wherein the covering body) comprises a flexible upper and a flexible lower surface, such that a user can wrap his fingers around the aero supports surrounded by the covering body.

22. The covering device according to claim 21, wherein the flexible covering body is adapted to be mounted to aero supports of different sizes.

23. The covering device according to claim 19, wherein the covering body comprises a sizeable padding layer, to be capable of absorbing shocks.

24. The covering device according to claim 19, wherein the covering body comprises a fiber fabric, which comprises in particular elastic fibers.

25. The covering device according to claim 24, wherein the fiber fabric comprises a smooth covering layer.
